(19) United States
(12) Patent Application Publication
(10) Pub. No.: US 2004/0099107 A1
(43) Pub. Date: May 27, 2004

(54) Apparatus and method for cutting sheet-type work material using a blade reciprocated via a tuned resonator

(75) Inventors: Darryl C. Stein, Andover, CT (US); Kenneth Lewis Harstine, Holyoke, MA (US); Matthew L. Reardon, Tolland, CT (US)

Correspondence Address: Richard R. Michaud, Esq., McCormick, Paulding & Huber LLP, 185 Asylum Street, CityPlace II, Hartford, CT, 06103, US

(73) Assignee: GERBER TECHNOLOGY, INC., Tolland, CT

(21) Appl. No.: 10/631,035

(22) Filed: Jul. 28, 2003

Related U.S. Application Data
(60) Provisional application No. 60/399,094, filed on Jul. 26, 2002.

(51) Int. Cl. B26D 1/00

(52) U.S. Cl. 83/13; 83/940; 83/575

(57) ABSTRACT

In a resonating assembly, a beam having a pickup thereon is positioned proximate to a magnet which passes across the pick up at a predetermined frequency. The passage of the magnet across the pick up establishes an alternating magnetic field that in turn causes the beam and pick up to vibrate. A blade is mounted on the beam and vibrates therewith so that when the blade is brought into engagement with a layer of sheet type work material the vibratory amplitude of the blade causes the blade to cut through the material as it is moved in engagement therewith.

### CROSS REFERENCE TO RELATED APPLICATION

This patent application claims priority to the Provisional Application, which was filed on Jul. 26, 2002, as application Ser. No. 60/399,094, the disclosure of which is incorporated herein by reference.

### FIELD OF THE INVENTION

The present invention is generally related to cutting sheet type work material and is more specifically directed to cutting said material via a vibrating blade.

### BACKGROUND OF THE INVENTION

Sheet type work material such as that used for making garments as well as leather and vinyl used for upholstery, both on furniture and in automobiles, is often cut by spreading the work material onto a flat support surface and running a reciprocating blade carried by a cutting head over the work material while the blade engages and cuts it. Generally, the cutting head is attached to a beam which can move along the cutting table while the cutting head moves along the beam in response to commands issued from a controller. These blades can reciprocate at rates of 20,000 cycles per minute and up. As such, complex mechanisms must be employed to drive the blade. In addition, these mechanisms must be able to move between a working position when the blade engages the work material and a non-working position when the blade is spaced away from the work material. In addition to the complexity of the mechanism, the high rate of reciprocation causes the cutter drives to be quite noisy. Moreover, it can be difficult to accurately control the blade when operating at these speeds.

Another difficulty that occurs with cutting machinery configured in the above-described manner is that the blades tend to wear rather quickly and require frequent changing.

Based on the foregoing, it is the general object of the present invention to improve upon or overcome the drawbacks of the prior art.

### SUMMARY OF THE INVENTION

The present invention resides in one aspect in an apparatus for cutting sheet-type work material that includes a resonator assembly. The resonator assembly comprises in part, a beam made from a suitable magnetically conductive material. A pick up, also formed from a suitable magnetically conductive material, is coupled to the beam and is positioned adjacent to at least one magnet. Resonating means associated with at least one magnet causes the magnet to move past the pick up at a predetermined rate thereby establishing an alternating magnetic field that in turn results in vibration of the beam and the pick up. A blade mounted to the beam also vibrates, thereby causing a cutting edge defined by the blade to reciprocate at the vibrating amplitude. The amplitude of the vibration will depend upon the configuration of both the beam and the blade. As the magnet passes proximate to the pickup an air gap is defined therebetween, this air gap is set at a predetermined width so as to maximize the transfer of magnetic flux and thereby the level of vibration in the beam. During operation, as the vibrating blade engages the work material, the sharpened edge defined by the blade cuts it.

Preferably, the magnet is mounted to a magnet retainer, which in turn is coupled to a motor. As the motor rotates, so too does the magnet retainer thereby causing the magnet attached thereon to pass across a face defined by the pick up. While one magnet has been described, the present invention is not limited in this regard as a plurality of magnets can be mounted onto the magnetic retainer with each passing across the face of the pick up upon rotation of the motor. The motor responds to commands issued from a controller which in turn monitors the vibrational levels in the beam and blade and compensates by excelerating or decelerating the motor dependent upon whether or not the work material has any significant damping effects on the blade during operation.

In an embodiment of the present invention, a return bar is also provided and is in magnetic communication with the beam. The magnet retainer is positioned between the pick up and the return bar. Any magnets mounted onto the magnet carrier will define generally opposing magnetic polls. These magnets are positioned such that when one of the polls is aligned with the pick up, the opposing poll is aligned with the return bar. Air gaps are defined between the magnet and each of the pick up and return bar so that when the magnet is aligned with the pick up a magnetic circuit is formed such that magnetic flux passes from the magnet into the pick up, travels down the beam into the return bar, and then back into the opposing poll of the magnet.

In another embodiment of the present invention, the above-described motor defines a drive shaft which extends through the return bar. The magnet retainer is mounted to the drive shaft for rotation therewith and includes at least one magnet attached thereto. As similarly described above, the magnet is positioned on the retainer so that opposing polls will align with the pick up and the return bar during operation.

In the preferred embodiment of the present invention, the resonating assembly described above is used with a cutter table. The cutter table includes a frame and a support surface mounted on the frame and adapted to carry at least one layer of work material. A carriage is coupled to the frame for movement relative thereto back and forth in a first coordinate direction in response to commands issued from the controller. A cutting head is coupled to the carriage and is also moveable back and forth there along in a second coordinate direction generally perpendicular to the first coordinate direction. The resonating assembly is coupled to the cutter head for movement between a working position wherein the blade engages the work material carried by the support surface and a non-working position wherein the blade is positioned away from the work material. During operation, the controller causes the carriage and the cutter head, as well as the resonating assembly, to cooperate and cut the work material.

The present invention also resides in another aspect in a method for cutting sheet type work material using a tuned resonator. In the method, at least one layer of sheet type work material is provided on a suitable support surface. A blade resonating at a known frequency is brought into engagement with the work material and moved thereover in response to commands issued from a controller. When the blade is in engagement with the work material, the resonance thereof causes the blade to cut through the material as it is moved therealong. The resonance of the blade can change as it engages the work material and is drawn therealong. This is caused in part due to the damping effects of the work material. Accordingly, the controller monitors the resonance of the blade and makes adjustments to the frequency of resonance to compensate for any damping caused by engagement with the work material.

An advantage of the present invention is that the resonating assembly is minimally complex and thereby more economical to manufacture, maintain, and operate.

### BRIEF DESCRIPTION OF THE DRAWINGS

FIG. 1 is a partial schematic illustration of a cutting table incorporating the present invention.

FIG. 2 is a perspective view of an embodiment of a mechanism for causing a blade to reciprocate via tuned resonance.

FIG. 3 is a partial schematic view of another embodiment of the present invention.

FIG. 4 is a partial schematic view of another embodiment of the present invention.

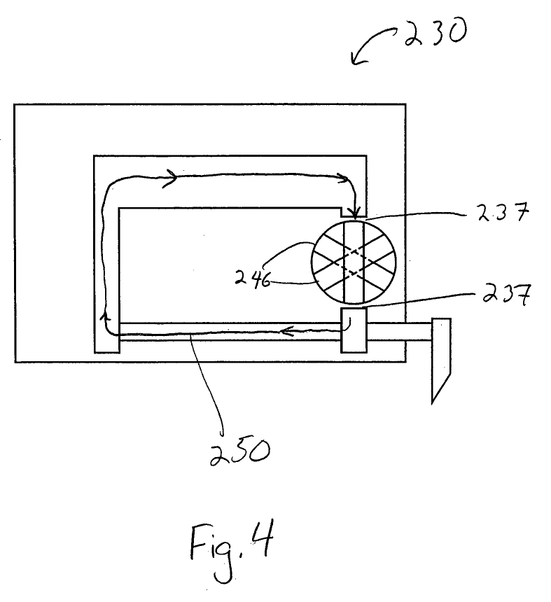

### DETAILED DESCRIPTION OF THE PREFERRED EMBODIMENTS

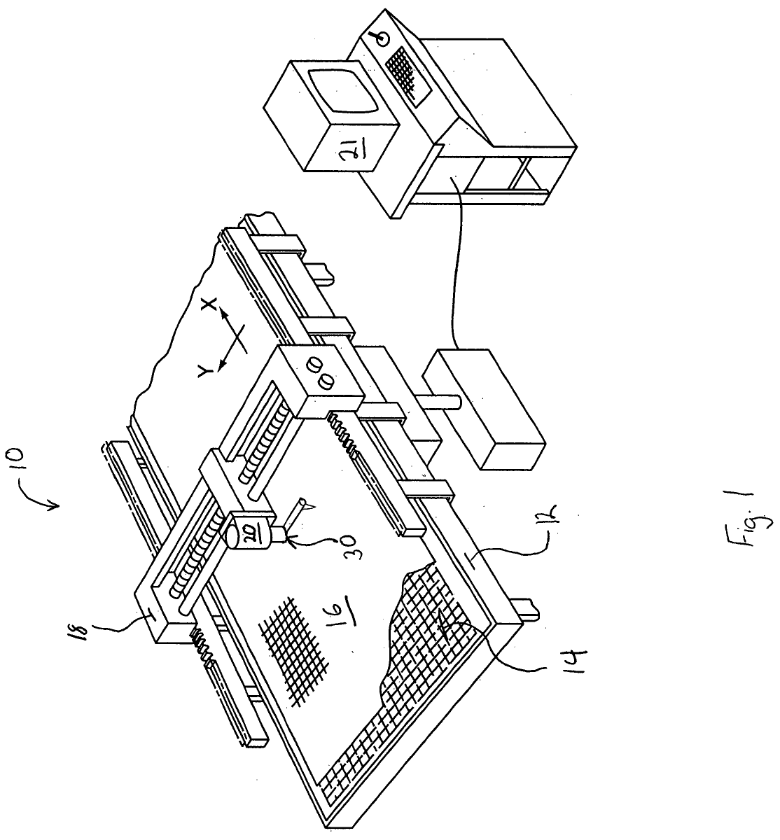

As shown in FIG. 1, a cutting table generally designated by the reference number 10, includes a frame 12 and a sheet-type work material support surface 14 adapted to carry at least one layer of work material 16, such as, but not limited to leather or vinyl. A carriage 18 is coupled to the frame for movement back-and-forth in a first direction as indicated by the arrows labeled “X.” A cutting head 20 is mounted on the carriage 18 and is movable back-and-forth therealong in a second direction as indicated by the arrows labeled “Y.” Both the carriage 18 and the cutting head 20 move in response to commands issued from a controller 21. As will be explained in detail below, a reciprocation assembly generally designated by the reference number 30 is mounted to the cutting head 20 and is movable between a working position, wherein they engage the work material 16, and a non-working position wherein they are lifted off of the work material. During operation, the carriage and the cutting head, 18 and 20 respectively, move in response to commands issued from the controller 20 over the work material 16. The reciprocation assembly 30, also in response to commands issued from the controller 21 moves between the working and non-working positions generating desired lines of cut in the work material 16.

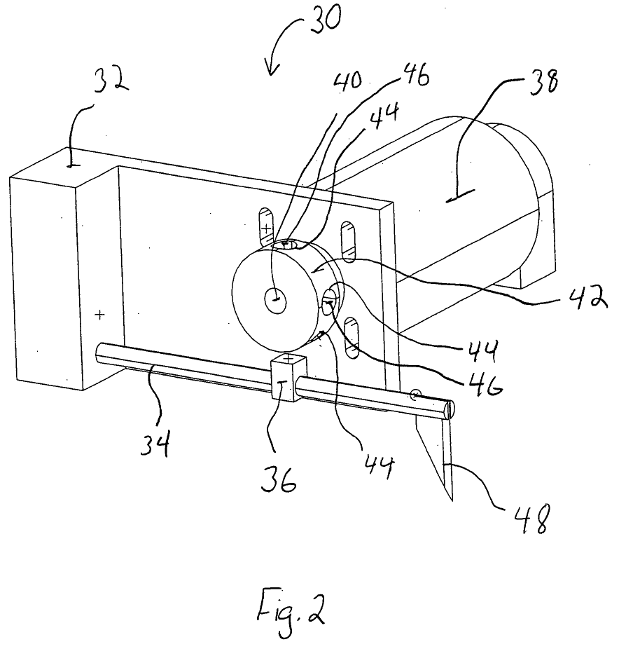

As shown in FIG. 2, the reciprocation assembly 30 includes a mounting bracket 32. A cantilevered rod 34 is attached to, and extends from a portion of the mounting bracket 32. A pickup 36, formed from a magnetically conductive material, such as, but not limited to mild steel is attached to the rod 34. A motor 38 is attached to the mounting bracket 32 and includes a drive shaft 40 extending through the mounting bracket. A magnet retainer 42 is mounted in the drive shaft 40 and includes a plurality of apertures 44 each adapted to retain a magnet 46 therein. Preferably, the apertures 44 and the magnets 46 are equally spaced from one another about the magnet retainer 42. A blade 48 is removably mounted at an end of the rod 34.

During operation, the motor 38 in response to commands issued from the controller 21, FIG. 1, causes the drive shaft 40 and thereby the magnet retainer 42 to rotate. As the magnets 46 mounted to the magnet retainer 42, pass over the pickup 36, the magnetic flux therebetween causes the pickup to be attracted toward the magnet retainer 42 thereby causing the rod to vibrate which in turn causes the blade 48 to vibrate. The vibrating blade 48 can them be employed to cut the work material 16, FIG. 1. Depending on the speed of the motor 38, a resonant frequency for the rod can be reached thereby increasing the vibratory amplitude of the blade 48. As the blade 28 engages the work material 16, damping will occur. Accordingly, the rate of rotation of the motor 38 must be adjusted via commands issued from the controller 21 to compensate for any damping effect the work material may have.

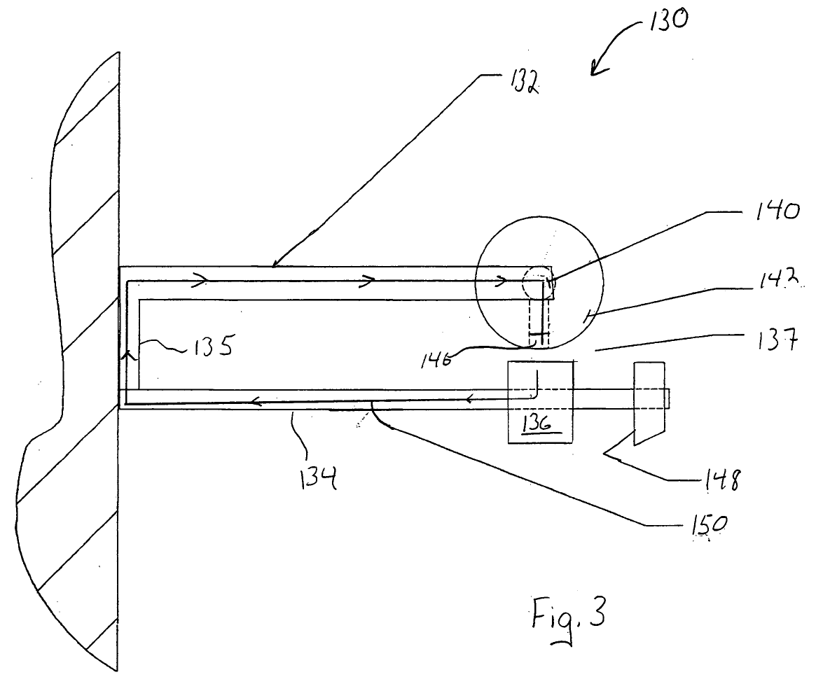

A second embodiment of the reciprocation assembly of the present invention, shown in FIG. 3, is generally designated by the reference numeral 130. The reciprocation assembly 130 is similar in many respects to the reciprocation assembly 30 described above, and therefore like reference numerals preceded by the number 1 are used to indicate like elements. The reciprocation assembly 130 differs from the reciprocation assembly 30 in that instead of being supported on a mounting bracket the motor is mounted on a return bar 132. The motor shaft extends through the return bar 132 and the magnet retainer 142 is coupled thereto. In the illustrated embodiment, the rod 134 engaged the leg 135 forming part of the return bar 132. An air gap 137 is defined between the pickup 136 and the magnet retainer 142.

With the reciprocation 130 assembly configured in the above-described manner, the flux density generated between a magnet 146 and the pickup 136 is maximized and follows a path indicated by the arrows labeled 150. Without the return bar 132, the magnetic flux would return to the magnet 146 via its outer edge. This return path restricts the magnetic coupling since magnetic coupling and therefore force is greatest when the air gaps in the magnetic circuit are minimized.

While preferred embodiments have been shown and described, various modifications and substitutions may be made without departing from the spirit and scope of the invention. Accordingly, it is to be understood that the present invention has been described by way of example, and not by limitation.

What is claimed is:

1. An apparatus for cutting sheet type work material comprising:
a resonator assembly, said resonator assembly including;
a magnetically permeable beam;
a magnetic pickup coupled to said beam;
a blade coupled to said beam and defining at least one sharpened edge;
at least one discreet magnet positioned proximate said pickup, said magnet and said pickup defining an air gap therebetween;
resonating means for moving said at least one discreet magnet relative to said pickup to create an alternating magnetic field, thereby causing said pickup to vibrate which in turn causes said beam and said blade to vibrate; and whereby
said vibration of said blade allows the sharpened edge to cut through the work material.

2. An apparatus as defined by claim 1 further comprising:
a frame having a support surface mounted thereon for carrying at least one layer of sheet-type work material;
a carriage coupled to said frame for movement back-and-forth there along in a first coordinate direction in response to commands issued from a controller;
a cutter head coupled to said carriage for movement back-and-forth in a second coordinate direction also in response to commands issued from said controller, said second coordinate direction being approximately perpendicular to said first coordinate direction; and
said resonator assembly being coupled to said cutter head for movement between a working position wherein said blade engages said work material carried on said support surface, and a non-working position wherein said blade is positioned away from said work material.

3. An apparatus as defined by claim 1 wherein said resonating means includes;
a magnet retainer having said at least one discrete magnet coupled thereto;
a motor;
said magnet retainer being rotatably coupled to said motor; and wherein
rotation of said motor and thereby said magnet retainer causes said at least one magnet to pass by said pickup at a known frequency thereby generating an alternating magnetic flux that in turn causes said blade to resonate.

4. An apparatus as defined by claim 2 wherein said resonating means includes;
a magnet retainer having said at least one discrete magnet coupled thereto;
a motor;
said magnet retainer being rotatably coupled to said motor; and wherein
rotation of said motor and thereby said magnet retainer causes said at least one magnet to pass by said pickup at a known frequency thereby generating an alternating magnetic flux that in turn causes said blade to resonate.

5. An apparatus as defined by claim 3 wherein said at least one magnet includes a plurality of magnets each mounted on said magnet retainer.

6. An apparatus as defined by claim 1 further comprising;
a mounting bracket, said beam being attached to and cantilevered from said mounting bracket.

7. An apparatus as defined by claim 1 further comprising:
a return bar,
said at least one magnet being positioned between said pickup and said return bar, said return bar being in magnetic communication with said beam.

8. An apparatus as defined by claim 7 wherein said return bar includes a leg portion depending therefrom, an end of which abuts said beam.

9. An apparatus as defined by claim 7 wherein said at least one magnet defines opposing poles, said magnet being positioned so that when one of said poles is aligned with one of said pickup and said return bar, the other of said poles is aligned with the other of said pickup and said return bar, and wherein during operation when said magnetic poles are aligned with said pickup and said return bar a magnetic circuit is formed and magnetic flux flows from said magnet through said beam and return bar and back into said magnet.

10. An apparatus as defined by claim 7 wherein:
said resonating means includes a magnet retainer rotatably coupled to an end of said return bar; and
said at least one magnet being attached to said magnet retainer.

11. An apparatus as defined by claim 10 wherein said magnet defines opposing poles and is attached to said resonating means so that when one of said poles is proximate said pickup, the other of said poles is proximate said return bar, and when one of said opposing ends is proximate said pickup, a first airgap is defined between an end of said magnet and said pickup, and a second airgap is defined between another end of said magnet and said return bar.

12. An apparatus as defined by claim 10 wherein said at least one magnet includes a plurality of magnets each attached to said magnet retainer.

13. An apparatus as defined by claim 3 wherein said resonator assembly further comprises:
a return bar having a surface that engages said beam;
said magnet retainer being positioned between said return bar and said pickup;
said at least one magnet defining generally opposing poles and being oriented in said magnet retainer such that when one of said poles is positioned proximate to said pickup, the other of said poles is positioned proximate to said return bar.

14. An apparatus as defined by claim 3 wherein said resonator assembly further comprises:
a return bar having a surface that engages said beam;
said motor defining a drive shaft that extends through said return bar, said magnet retainer being mounted for rotation on said drive shaft; and wherein
when one of said opposing ends is proximate said pickup, a first airgap is defined between an end of said magnet and said pickup, and a second airgap is defined between another end of said magnet and said return bar.

15. An apparatus as defined by claim 13 wherein said at least one magnet includes a plurality of magnets.

16. An apparatus as defined by claim 14 wherein said at least one magnet includes a plurality of magnets.

17. A method employing a tuned resonator for use in cutting sheet-type work material comprising:
providing at least one layer of work material carried on a support surface;
providing a cutter having a cutting blade thereon, said cutting blade forming part of a resonator assembly which, in response to commands issued from a controller causes said blade to vibrate at a predetermined frequency;
causing said vibrating cutting blade to engage said work material;
moving said vibrating cutting blade in response to commands issued from a controller in a predetermined path along said work material to cut pattern pieces therefrom;
monitoring the amplitude and frequency at which said cutting blade vibrates to determine if engagement with said work material has any damping effect on said vibration of said cutting tool; and
compensating for any damping by tuning the frequency at which said cutting blade vibrates.

18. A method as defined by claim 17 wherein said step of providing a cutter includes:
providing a cutting table having a frame that includes a support surface mounted thereon for carrying at least one layer of sheet-type work material, a carriage coupled to said frame for movement back-and-forth there along in a first coordinate direction in response to commands issued from a controller, a cutter head coupled to said carriage for movement back-and-forth in a second coordinate direction also in response to commands issued from said controller, said second coordinate direction being, approximately perpendicular to said first coordinate direction; and a resonator assembly being to said cutter head for movement between a working position wherein said blade engages said work material carried on said support surface, and a non-working position wherein said blade is positioned away from said work material; and wherein
said resonator assembly includes a magnetically permeable beam, a magnetic pickup coupled to said beam, a blade coupled to said beam and defining at least one sharpened edge, at least one discreet magnet positioned proximate said pickup, said magnet and said pickup defining an air gap therebetween, resonating means for moving said at least one discreet magnet relative to said pickup to create an alternating magnetic field, thereby causing said pickup to vibrate which in turn causes said beam and said blade to vibrate.
